(19) United States
(12) Patent Application Publication
(10) Pub. No.: US 2018/0116108 A1
(43) Pub. Date: May 3, 2018

(54) Improvements In The Mounting Of A Roller Assembly For A Mower Deck

(71) Applicant: Trimax Mowing Systems NZ Limited, Waikato Mail Centre, Hamilton (NZ)

(72) Inventors: Keith Ross Mabey, Otumoetai, Tauranga (NZ); Stefan Josef Burgi, Greerton, Tauranga (NZ)

(21) Appl. No.: 15/567,875

(22) PCT Filed: Apr. 20, 2016
(86) PCT No.: PCT/NZ2016/050063

§ 371 Date: Oct. 19, 2017

(30) Foreign Application Priority Data
Apr. 20, 2015 (NZ) 707193

(51) Int. Cl. A01D 34/81

(52) U.S. Cl. CPC A01D 34/81

(57) ABSTRACT

This invention relates to a mounting assembly for a roller having a bearing and a fastener. The fastener is at least partially shrouded by a sleeve, the end of which is keyed into the roller. Use of the sleeve provides an additional bearing surface to allow the roller to rotate with the bearing. Should the bearing seize, the sleeve and the roller are still able to rotate without affecting the fastener, that is, the fastener does not unravel and disengage from the housing. This invention has particular application to mounting of rollers to mower decks of a mowing implement.

### STATEMENT OF CORRESPONDING APPLICATIONS

This application is based on the provisional specification filed in relation to New Zealand Patent Application No. 707193, filed on 20 Apr. 2015, the entire contents of which are incorporated herein by reference.

### TECHNICAL FIELD

The invention relates to the mounting of rollers to a mechanical apparatus. The invention has particular application to the mounting of rollers to the mower deck of a mowing implement although this is not meant to be limiting and the invention may be used with many types of apparatus requiring rollers.

### BACKGROUND ART

Mowers are known for cutting grass and plant matter. These devices generally comprise one or more cutting decks with mowing blades. The mowing blades are operatively coupled to a drive assembly which causes them to rotate and thereby cut grass and plant matter.

For safety, the cutting decks, also known as mower decks, have a housing within which the mowing blades are located so that they are not exposed. These housings will often include rollers to support the housing and mowing blades to maintain the desired height above the ground and therefore the length at which the grass is to be cut.

The ends of the rollers include roller bearings which are in turn mounted directly or indirectly, for example using a bracket, to the housing of the mower. In some cases, a threaded fastener passes through the mounting point and the bearing and into the roller in order to secure it. The roller is able to rotate, with the fastener, by virtue of the centre race of the roller bearings.

Alternative left- and right-handed threaded fasteners are often used to mount the rollers. However, this means that particular care is required that the correct fasteners are used when installing the rolling mounting assemblies to the housing of the mower deck. Failure to do so may result in the roller assembly being put together backwards.

In other cases, the roller may include a protruding shaft from its ends which would engage with a bearing. Effectively, these are clamped together using locking collars or similar structures so that the centre race of the roller bearing rotates with the roller.

It is relatively common for roller bearings to seize. Mowers are exposed to a lot of moisture and dirt particles which can penetrate into the roller bearing.

Where fasteners have been used to mount the roller, should they have the same thread direction, this can lead to one of the fasteners unravelling (which one unravels depends on the direction of rotation of the roller) if the roller bearing seizes. Consequently, one of the ends of the roller can become disengaged should the roller bearing seize.

The use of alternative left- and right-handed threaded fasteners means that should the roller bearing seize, the roller should remain attached to its mountings, provided it continues to rotate in the same direction.

Where the roller has a shaft that engages with the roller bearing, the clamping force between them can be insufficient to prevent it rotating. Thus, with the roller bearing unable to rotate, the shaft rotates within it. This may damage the shaft. When fasteners are used, they may also be damaged.

When the roller bearing, fastener or shaft requires attention (maintenance or replacement), the user of the mower then has to take it out of use. This is concerning for outdoor contractors or the like who require the mower for completion of their ongoing work.

All references, including any patents or patent applications that may have been cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to” the stated elements, integers or steps.

It is an object of the present invention to address the foregoing problems or at least to provide the public with a useful choice.

Further aspects and advantages of the present invention will become apparent from the ensuing description which is given by way of example only.

### DISCLOSURE OF THE INVENTION

According to one aspect of the present invention, there is provided a mounting assembly for a roller for a mowing implement that includes a mower deck to which the roller is to be mounted, the mounting assembly including:

a roller bearing, wherein the roller bearing includes a passage therethrough for a fastener,

a fastener, wherein the fastener includes a shaft configured to pass through the passage,

characterised in that

the mounting assembly includes a sleeve for at least a portion of the exterior of the shaft of the fastener, and wherein a portion of the sleeve is configured to engage with the roller.

According to another aspect of the present invention, there is provided a mowing implement that includes a mower deck, wherein the mower deck includes a mounting assembly for a roller, the mounting assembly including:

a roller bearing, wherein the roller bearing includes a passage therethrough for a fastener,

a fastener, wherein the fastener includes a shaft configured to pass through the passage,

characterised in that

the mounting assembly includes a sleeve for at least a portion of the exterior of the shaft of the fastener, and wherein a portion of the sleeve is configured to engage with the roller.

According to another aspect of the present invention, there is provided a sleeve when used with a fastener in a mounting assembly for a roller for a mowing implement that includes a mower deck to which the roller is to be mounted, the sleeve including

a cylindrical body having a first end and a second end,

characterised in that

the body includes a central passage complementary to a shaft of the fastener, and wherein a portion of the first end of the sleeve is configured to engage with the roller.

The invention is a mounting assembly for a roller that includes a bearing and a fastener. The fastener is at least partially shrouded by a sleeve, the end of which is keyed into the roller. The use of the sleeve provides an additional bearing surface to allow the roller to rotate with the bearing. However, should the bearing seize, the sleeve, and therefore the roller, is still able to rotate without affecting the fastener. This means that the fastener does not unravel and disengage from the housing.

The invention has application to ground work equipment, roller conveyor systems and other applications which utilise rollers. The invention has particular application for mowing implements. However, it may be suitable for any mechanical apparatus in which a roller is used to roll the ground or any other surface directly or to support it at a desired height. For example, the invention may be used in a rotary hoe.

However, in preferred embodiments, the invention is to be used with a mowing implement in which the implement that includes a mower deck and reference shall now be made to this effect throughout the remainder of this specification.

A roller should be understood to be an elongate cylinder which in use is positioned relative to the mower deck such that it is in light contact with the substrate over which it is to be used. It may be made of any suitable material such as a suitable length of standard pipe. This is not meant to be limiting; persons skilled in the art will readily appreciate ways in which the roller may be constructed or otherwise formed.

The ends of the roller include a cap which is configured to prevent or minimise damage to the substrate over which the mower is to be used. The cap also includes a central threaded aperture.

To mount the roller to the mower deck, or ultimately whatever apparatus with which the roller is to be used, requires the use of a mounting assembly, which includes a roller bearing, a fastener, and a sleeve for the fastener. It may also optionally include brackets (between which the roller is effectively suspended). These components shall now be described.

The brackets may take any form that will be recognised by a person skilled in the art as being suitable for the task.

The brackets should be understood to include a first aperture through which the fastener passes and another aperture (or a series of apertures) by which it is secured to the mower deck.

In some embodiments of the present invention, the second aperture may be in the form of an elongate slot; this allows the relative height of the brackets, and therefore the roller suspended between the brackets, to be adjusted.

As noted above, the bracket is an optional structure. In some embodiments, the roller may be mounted directly to the mower deck using the mounting assembly. In these embodiments, the mower deck will be understood to include apertures for either end of the roller. These may be in the form of a slot or even a series of apertures for height adjustment of the roller.

The roller bearing should be understood to be any bearing suitable for use with a roller for a mower deck. Such roller bearings include a central passage through which a fastener may pass.

The roller bearing has an inner portion or centre race (which carries the central passage) and an outer portion. The inner portion of the roller bearing engages with the end of the roller in use, such that it rotates with the fastener as a common unit. In some embodiments, the outer portion of the roller bearing may be fixed to the mower deck or to the bracket (which in turn is mounted the mower deck). It will be appreciated that this means the outer portion of the bearing provides the means by which the roller is mounted to the bracket (or the mower deck).

In preferred embodiments, these portions are retained within a roller bearing housing and it is this which is mounted to the bracket or mower deck.

The fastener should be understood to include a head and a shaft, the shaft passing through the passage of the roller bearing. The shaft has two portions; a first portion, proximate the head, is unthreaded while a second portion is complementarily threaded and engage with the thread in the cap end of the roller.

Preferably, the fastener is a bolt and shall be referred to as such for the remainder of the specification. However, it is not intended to be limiting and other fasteners such as screws or the like may also be used.

In use, the shaft of the bolt passes through the first aperture of the bracket (or the mower deck as the case may be) to which the roller is to be mounted. The underside of the head (i.e. the side of the head closest to the shaft of the bolt) bears against the sleeve. It will be appreciated that the first aperture is dimensioned larger that the diameter of the head of the head of the bolt to allow it to rotate unhindered.

The sleeve should be understood to be a substantially cylindrical member with a body having a central passage or bore through which the shaft of the bolt passes. Therefore, the interior surface of the sleeve is in contact with the shaft of the bolt, while the exterior surface of the sleeve should be understood to be in contact with the interior of the central passage of the roller bearing.

In use, the mating or contact surfaces of the sleeve and shaft of the bolt are unthreaded. It will be appreciated that this means that the bolt is able to rotate within the central passage of the sleeve and positively secures the sleeve and bearing against the end cap of the roller. This is particularly useful should the roller bearing seize as the bolt does not lock in with it. It is able to still rotate with the sleeve and roller. Thus, the sleeve acts as a sacrificial bearing surface should excessive forces cause the bearing to rotate on the outside surface of the sleeve.

Furthermore, as the risk of the roller separating from the mounting assembly is now considerably reduced, the roller may be mounted using bolts with the same handed thread. This greatly simplifies the mounting of the roller to the mower deck.

The dimensions of the sleeve, the shaft of the bolt and the passage way of the inner portion of the roller bearing are such that these components all fit snugly together but without compromising the ability for the sleeve to rotate about the shaft of the bolt.

The sleeve should be understood to have a first end and a second end.

The first end of the sleeve is configured to engage with the roller. It will be appreciated that this means that the roller, sleeve and bolt rotate, together with the inner portion of the roller bearing, as a single assembly.

In preferred embodiments, the first end of the sleeve engages with the end of the roller or with the end cap of the roller, if one is present.

As discussed above, the roller includes a cap to cover its ends. In preferred embodiments of the invention, the end cap is configured with a surface complementary to the first end of the sleeve. This acts as a key further locking the sleeve relative to the roller.

It should be understood that the first end of the sleeve and the end cap of the roller may be configured in any number of ways to achieve this ‘key and lock’ effect. For example, the end of the sleeve may include a protrusion complementary to a recess in the end cap. Alternatively, the end cap may be provided with the protrusion that engages with a recess in the first end of the sleeve.

The second end of the sleeve abuts the head of the fastener. In some embodiments of the present invention, the second end may be configured with a shoulder or slight protrusion, one side of which would abut a surface of the roller bearing. The other side bears against the underside of the bolt.

Similarly, the end cap and inner portion of the roller bearing may also include complementary protrusions and recesses such that they lock together in a similar manner.

It should be appreciated that the invention may also have application to rollers having shafts arising from either end, these shafts being configured to be inserted through a passage way in the centre race of the roller bearing (instead of using a fastener).

According to another aspect of the present invention, there is provided a mounting assembly for a roller for a mowing implement that includes a mower deck to which the roller is to be mounted, wherein the roller includes a shaft extending from an end, and wherein the mounting assembly including:

a roller bearing, wherein the roller bearing includes a passage therethrough for the shaft,

characterised in that

the mounting assembly includes a sleeve for at least a portion of the exterior of the shaft of the roller, and wherein a portion of the sleeve is configured to engage with the end of the roller.

According to another aspect of the present invention, there is provided a mowing implement that includes a mower deck, wherein the mower deck includes a mounting assembly for a roller, wherein the roller includes a shaft extending from an end, the mounting assembly including:

a roller bearing, wherein the roller bearing includes a passage therethrough for the shaft of the roller,

characterised in that

the mounting assembly includes a sleeve with a passage for at least a portion of the exterior of the shaft of the roller, and wherein a portion of the sleeve is configured to engage with the roller.

In these embodiments, the sleeve and roller bearing is substantially as previously described. The shaft of the roller would pass through the centre race of the roller bearing. The end of the shaft is threaded or otherwise configured to engage with a clamping component, such as a rotational locking nut or the like in order to secure the shaft to the centre race of the roller bearing.

In use, the shaft of the roller would be inserted through the passage of the sleeve and the clamping component and through the centre race of the roller bearing with which it would be used. Thus, the shaft contacts the inner surface of the sleeve, while the outer surface of the sleeve is in contact with the surfaces of the passage way of the centre race of the roller bearing.

The first end of the sleeve would key in with a recess surrounding the shaft where it arises from the end of the roller so that it rotates with the roller. It will be appreciated that the interior of the sleeve is configured such that it does not inhibit the clamping component used to secure the shaft relative to the centre race of the roller bearing.

In this embodiment, should the roller bearing seize such that the centre race becomes locked and the clamping component fails, the sleeve would still be able to rotate with the roller. This prevents the internal shaft from becoming damaged (which may be the case if the sleeve was not present).

The invention offers a number of advantages including:
provides an additional sacrificial bearing surface in the event the roller bearing seizes;
provides a simple locking component to retain the roller bearing in line with the axis of rotation of the roller;
simplifies mounting of the roller to the mower deck or to whatever apparatus with which the roller is to be used;

at the very least, the invention offers the public a useful choice.

### BRIEF DESCRIPTION OF DRAWINGS

Further aspects of the present invention will become apparent from the following description which is given by way of example only and with reference to the accompanying drawings in which:

FIG. 1 is an exploded perspective view of one embodiment of the present invention;

FIG. 2 is a perspective view of the embodiment illustrated in FIG. 1;

FIG. 3 is a cross-section side view of the embodiment illustrated in FIG. 1;

FIG. 4 is a rear perspective view of the sleeve of the present invention;

FIG. 5 is a front perspective view of the end cap of the present invention; and

FIG. 6 is a cross-section side view of an alternative embodiment of the present invention.

### DETAILED DESCRIPTION OF THE FIGURES

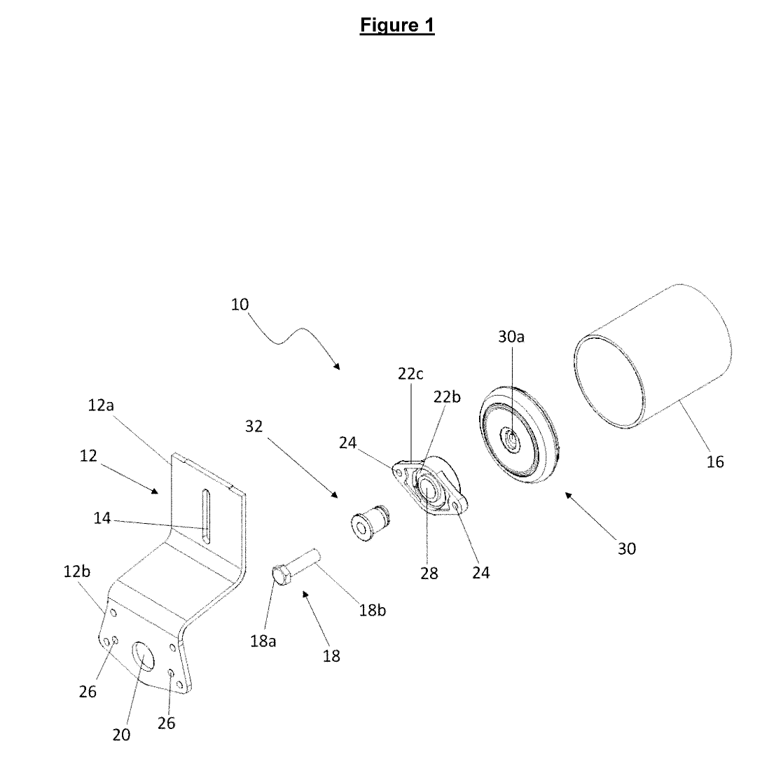

The invention, a mounting assembly for a roller (generally indicated by arrow 10), is depicted in FIG. 1 in an exploded form.

It includes a bracket (12) which, in use, would be secured to the mower deck (not shown) via bolts (not shown) passing through the slot (14) in the upper section (12a) of the bracket. The slot allows the height of the bracket, relative to the mower deck, to be adjusted to the user's requirements.

To mount the roller (16) to the bracket (12), a bolt (18) passes through the opening (20) in the lower section (12b) of the bracket and into the roller. It will be seen that the opening is dimensioned such that it is larger than the head (18a) of the bolt so as to not hinder its rotation.

Interposed between the bolt (18) and the roller (16) is a roller bearing (22) formed from a centre or inner race (22a) and an outer race (22b). The housing (22c) of the roller bearing is mounted to the bracket using fasteners (not shown) passing through apertures (24) and into corresponding holes (26) in the bracket. When the roller rotates, the centre race rotates with it.

The centre race (22a) includes a central passage way (28) through which the shaft (18b) of the bolt (18) passes to engage with the end cap (30) of the roller (16). The end cap includes a central aperture (30a) into which the bolt is threaded.

Between the shaft (18b) of the bolt (18) and the central passage way (28) of the centre race (22a) is provided a sleeve (32). This sleeve rotates with the roller (16), centre race and bolt, but should the roller bearing (22) seize, it is able to continue to rotate with the roller ensuring that the bolt does not unravel in use.

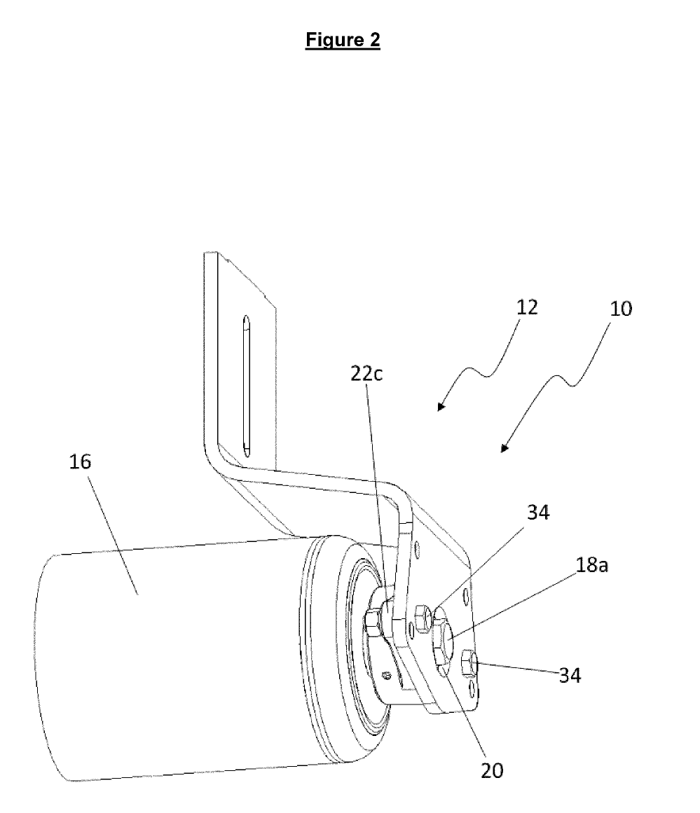

Turning now to FIG. 2, the invention (10) can be seen in a perspective view when in an assembled state. In this view, it can be seen that the head (18a) of the bolt is smaller than the aperture (20) provided in the bracket (12) to ensure that it can freely rotate with the roller (16). Also visible are the fasteners (34) that secure the bearing assembly housing (22c) to the bracket.

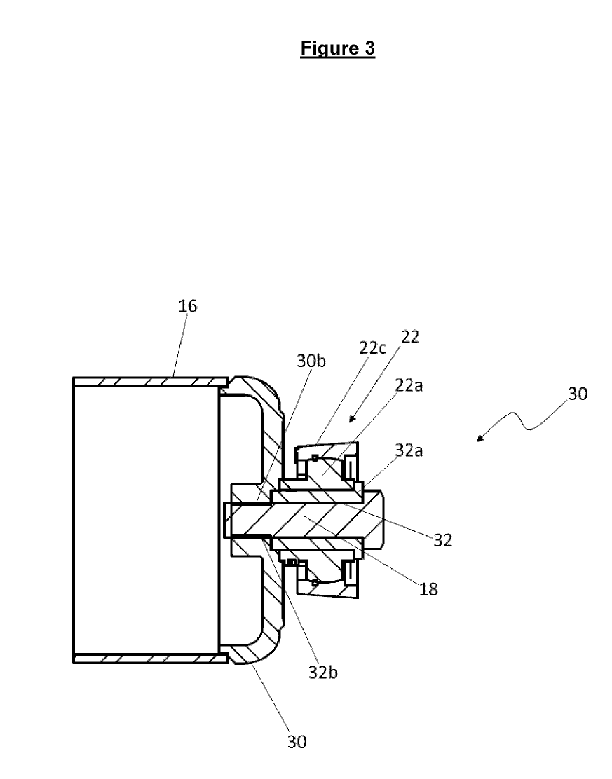

FIG. 3 shows the invention (10) in a side cross-section view. It will be seen that the bolt (18) passes through the centre race (22a) of the roller bearing (22) and into the roller end cap (30).

The first end (32a) of the sleeve (32) bears against the roller bearing (22) with the second end (32b) keyed into a recess (30b) in the end cap (30) of the roller (16).

This makes the sleeve (32), the centre race (22a) of the roller bearing (22), and roller (16), by virtue of the keyed in end cap (30) a unitary and rotatable structure. In the meantime, the housing (22c) would be secured to the bracket (not shown) or alternatively to the mower deck (not shown) with which the invention is to be used.

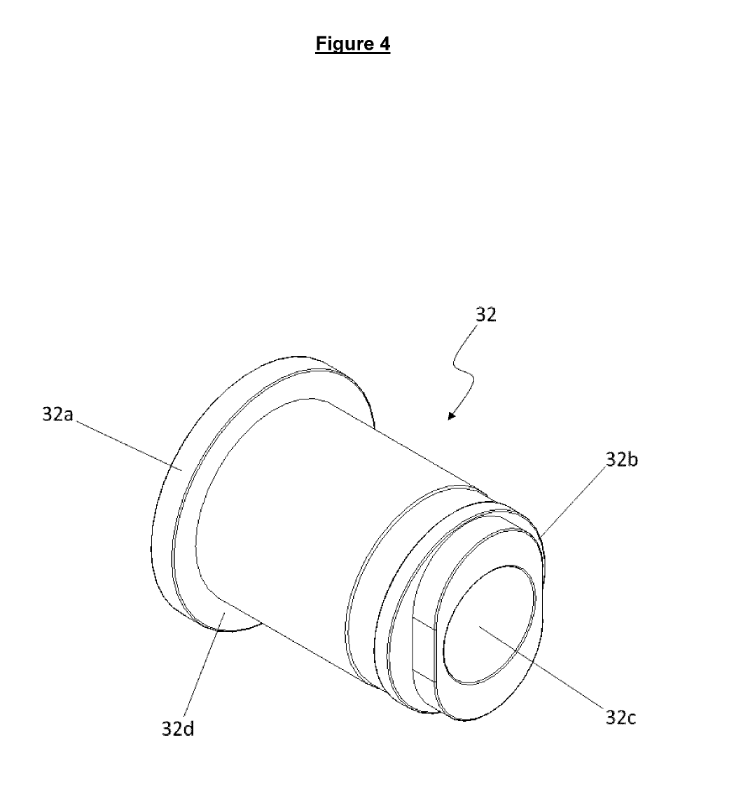

The sleeve (32) is seen in closer detail in FIG. 4. It has two ends (32a and 32b). The second end keys into the end cap of the roller (not shown) to help lock it so that it rotates with the roller. This end is an ovoid projection and at its centre can be seen the passageway (32c) through which the bolt (not shown) will pass in use.

The first end (32a) of the sleeve (32) is provided as a shoulder; this bears against the roller bearing (not shown) on one side (32d) and against the underside of the head of the bolt (not shown) on the other side (not visible).

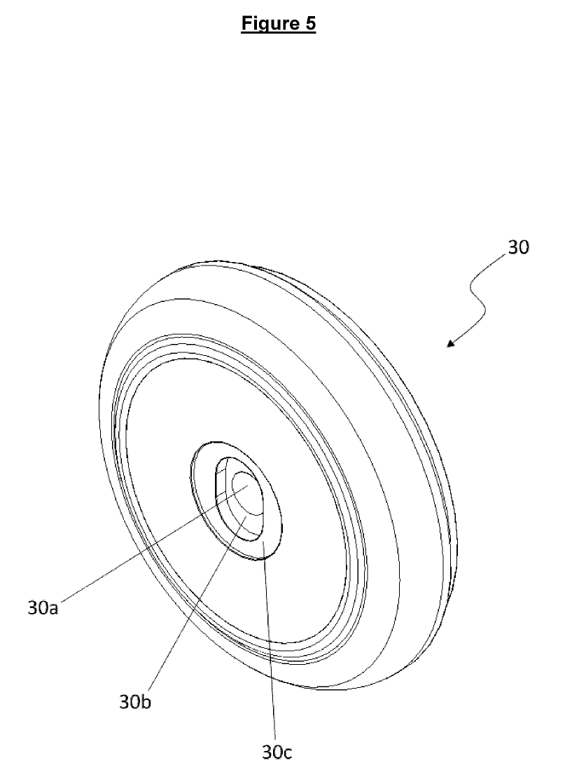

The projection (32b) corresponds with the recess (30b) of the end cap (30) illustrated in FIG. 5. The combination locks these two together. At the base of the recess is the aperture (30a) through which the bolt (not shown) passes. The recess itself is within a shallow depression (30c) into which the centre race of the roller bearing (not shown) also keys into the end cap.

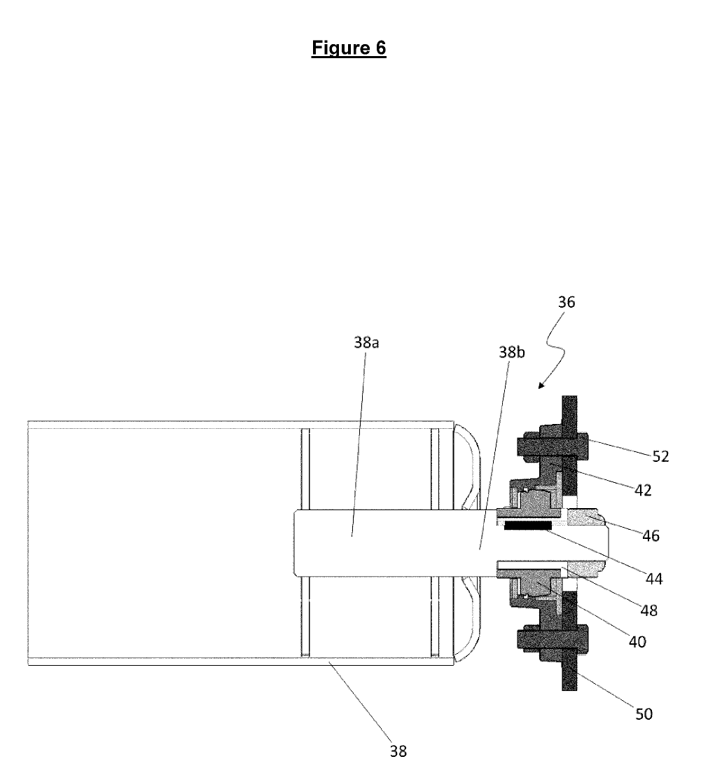

An alternative embodiment of the invention (36) is illustrated in FIG. 6. Here, the roller (38) includes an integrated shaft (38a), a portion (38b) of which is inserted into the central race (40) contained within the roller bearing housing (42).

The shaft (38a) is secured by a rotational locking element (44) and a nut (46). A sleeve (48) is located between the central race, shaft, and rotational locking element. Should the central race fail and seize, the sleeve allows the shaft to continue to rotate.

The roller housing bearing (42) is secured to a portion of the mower deck (50) by fasteners (52).

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

Aspects of the present invention have been described by way of example only and it should be appreciated that modifications and additions may be made thereto without departing from the scope thereof as defined in the appended claims.

1. A mounting assembly for a roller for a mowing implement that comprises a mower deck to which the roller is to be mounted, the mounting assembly comprising:
a roller bearing, wherein the roller bearing comprises an inner portion and an outer portion, and includes a passage therethrough,
a fastener, wherein the fastener includes a shaft,
the mounting assembly comprises a sleeve with a passage for at least a portion of an exterior of the shaft of the fastener, wherein at least a portion of an exterior of the sleeve is configured to pass through the passage of the roller bearing and wherein the inner portion of the roller bearing engages with an end of the roller and a portion of the sleeve is configured to engage with the roller, such that the sleeve rotates with the roller in use.

2. The mounting assembly as claimed in claim 1 wherein the inner portion is configured to rotate relative to the outer portion.

3. (canceled)

4. The mounting assembly as claimed in claims 1, wherein the shaft of the fastener has a threaded portion and an unthreaded portion.

5. The mounting assembly as claimed in claim 4, wherein the unthreaded portion of the shaft is in contact with the passage of the sleeve.

6. The mounting assembly as claimed in either claim 4, wherein the threaded portion of the shaft engages with the end of the roller.

7. The mounting assembly as claimed in claims 1, wherein the sleeve has a first end and a second end.

8. The mounting assembly as claimed in claim 7, wherein the first end of the sleeve is configured to engage with the end of the roller via complementary protrusions and recesses.

9. The mounting assembly of claim 7, wherein the fastener has a head, wherein the second end of the sleeve abuts the head.

10. The mounting assembly as claimed in claim 2, wherein the outer portion of the roller bearing is configured to be mounted to the mower deck.

11. The mounting assembly as claimed in claim 1, wherein the mounting assembly comprises a pair of brackets between which the roller is to be suspended and wherein the brackets include apertures for fasteners to mount the brackets to the mower deck.

12. A mowing implement that includes a mower deck, wherein the mower deck comprises a mounting assembly for a roller, the mounting assembly as claimed in claim 1.

13. (canceled)

14. A mounting assembly for a roller for a mowing implement that comprises a mower deck to which the roller is to be mounted, wherein the roller includes a shaft extending from an end, and wherein the mounting assembly comprises:
a roller bearing, wherein the roller bearing comprises an inner portion and an outer portion, and includes a passage therethrough for the shaft,
the mounting assembly comprises a sleeve for at least a portion of the exterior of the shaft of the roller, and wherein the inner portion of the roller bearing engages with the shaft of the roller and a portion of the sleeve is configured to engage with the end of the roller.

15. The mounting assembly as claimed in claim 14, wherein the shaft has an end which is configured to engage with a clamping component.

16. The mounting assembly as claimed in claim 15, wherein the clamping component is a rotational locking nut.

17. The mounting assembly as claimed in claim 14, wherein the sleeve has an exterior, and wherein at least a portion of the exterior of the sleeve passes through the passage of the roller bearing.

18. The mounting assembly as claimed in claim 14, wherein the sleeve has a first end and a second end.

19. The mounting assembly as claimed in claim 18, wherein the first end of the sleeve is configured to engage with the end of the roller.

20. A mowing implement that includes a mower deck, wherein the mower deck comprises a mounting assembly for a roller, wherein the roller comprises a shaft extending from an end, wherein the mounting assembly is as claimed in claim 14.

21. (canceled)

22. (canceled)

23. (canceled)
